(19) United States
(12) Patent Application Publication
(10) Pub. No.: US 2008/0277493 A1
(43) Pub. Date: Nov. 13, 2008

(54) FOUNTAIN LAMP

(75) Inventor: Been-Tzaw LIAO, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Gooten Innolife Corporation, Taichung Hsien (TW)

(21) Appl. No.: 11/747,688

(22) Filed: May 11, 2007

(51) Int. Cl. F21V 33/00

(52) U.S. Cl. 239/20; 362/96

(57) ABSTRACT

A fountain lamp includes a housing having a bottom inlet, a pump unit mounted inside the housing for pumping a fluid from the inlet into a delivery pipeline, a light emitting device mounted in the housing for controllably emitting light out of the housing, a control unit for controllably driving the pump unit and the light emitting device, and a shifting unit having a base mounted in the housing and having a through hole connected to the delivery pipeline and a spray-pattern dial rotatably mounted in the base. The spray-pattern dial has multiple chambers, multiple guide holes respectively connected to the chambers and selectively set in communication with the through hole, and multiple sets of outlets respectively connected to the chambers for selectively exit of the fluid from the chambers and the housing for different fluid spray patterns.

### BACKGROUND OF THE INVENTION

1. Field of the Invention

The present invention relates to lighting fixtures and more specifically, to a fountain lamp that provides a dynamic visual effect.

2. Description of the Related Art

A conventional fountain lamp is used as an ornamental device to produce a visual effect. Taiwan Patent Pub. No. M285467 disclosed a fountain lamp, which comprises a transparent box, a cistern mounted inside the transparent box, a water pump mounted inside the transparent box, a transparent tube connected to the water pump for enabling the water pump to eject water therethrough into the cistern, and a light emitting disk mounted to the transparent tube for giving off light, whereby the light projected onto the water spray to enable special dynamic visual effect. According to this design, a power cable is required to provide the necessary working voltage. This design must be used in a dry environment. If the fountain box is submerged in water for operation, a leakage of electricity may occur. Further, this design of the fountain box is large-sized, having a specific gravity greater than water. Therefore, it cannot float on water for operation. Further, due to the space limitation of the transparent box, the visual effect of the water spray is limited.

Taiwan Patent Pub. No. 181497 disclosed a water-dancing toy which power supply is direct current (DC) to be safer in operation. However, this design still has the same other drawbacks as the aforesaid prior art design.

### SUMMARY OF THE INVENTION

The present invention has been accomplished under the circumstances in view. It is the main object of the present invention to provide a fountain lamp, which is safe in operation and suitable for use in a wet environment.

To achieve the main object of the present invention, the fountain lamp is composed of a housing having an accommodation chamber and an inlet located on a bottom side of the housing for entry of a fluid; a pump unit mounted in the accommodation chamber and having a delivery pipeline connected to the inlet for delivering the fluid; a light emitting device mounted to the accommodation chamber for emitting the light out of the housing; a control unit electrically connected to the pump unit and the light emitting device for driving the pump unit and the light emitting device; and a shifting unit having a base mounted to the accommodation chamber and having a through hole in communication with the delivery pipeline, and a spray-pattern dial rotatably mounted to the base and having a plurality of chambers, a plurality of guide holes respectively connected to the chambers, one of which corresponds to the through hole, and multiple sets of outlets respectively in communication with the chambers for exit of the fluid.

By means of the aforesaid arrangement, the fountain lamp can float on the fluid for safe operation and can be safely operated in wet environment.

### BRIEF DESCRIPTION OF THE DRAWINGS

FIG. 1 is a perspective view of a fountain lamp according to the present invention.

FIG. 2 is an exploded view of the fountain lamp according to the present invention.

FIG. 3 is similar to FIG. 2, viewed from another angle.

FIG. 4 is an exploded view of a part of the present invention, showing the structure of the top cover and the shifting unit.

FIG. 5 is similar to FIG. 4, viewed from another angle.

FIG. 6 is a perspective view of the fountain lamp after removal of the top cover.

FIG. 7 is an exploded view of a part of the present invention, showing the structure of the shifting unit.

FIG. 8 is similar to FIG. 7, viewed from another angle.

FIG. 9 is a sectional view taken along a line 9-9 of FIG. 1.

FIG. 10 is a sectional view taken along a line 10-10 of FIG. 1.

FIG. 11 is a circuit block diagram of the present invention.

### DETAILED DESCRIPTION OF THE INVENTION

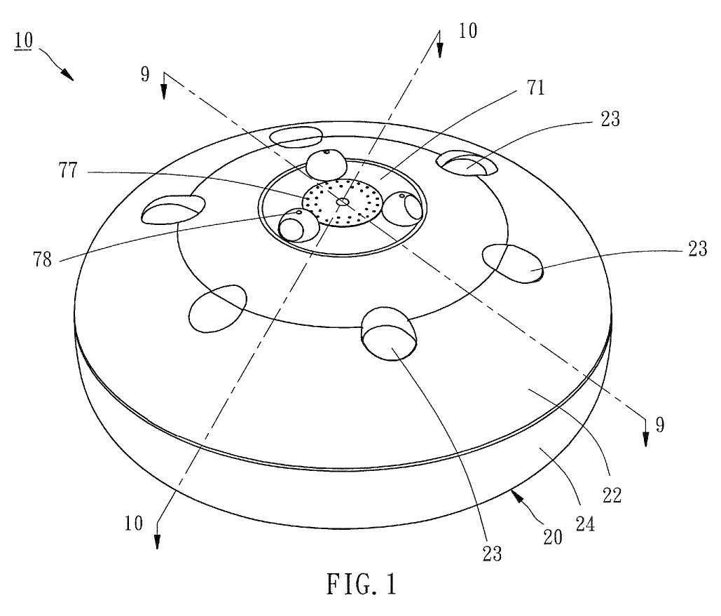

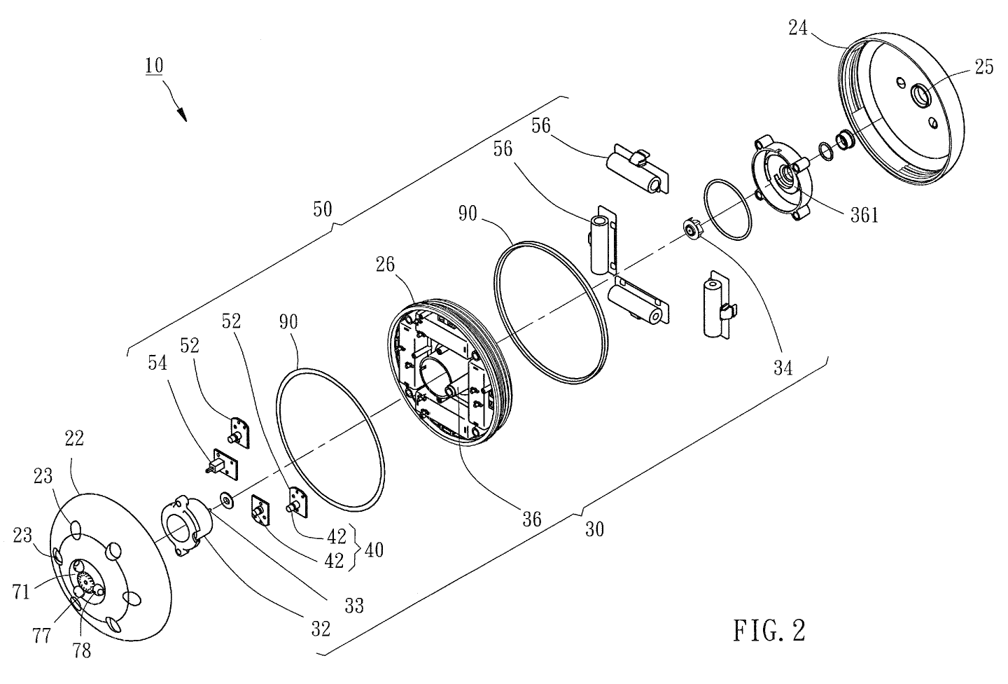

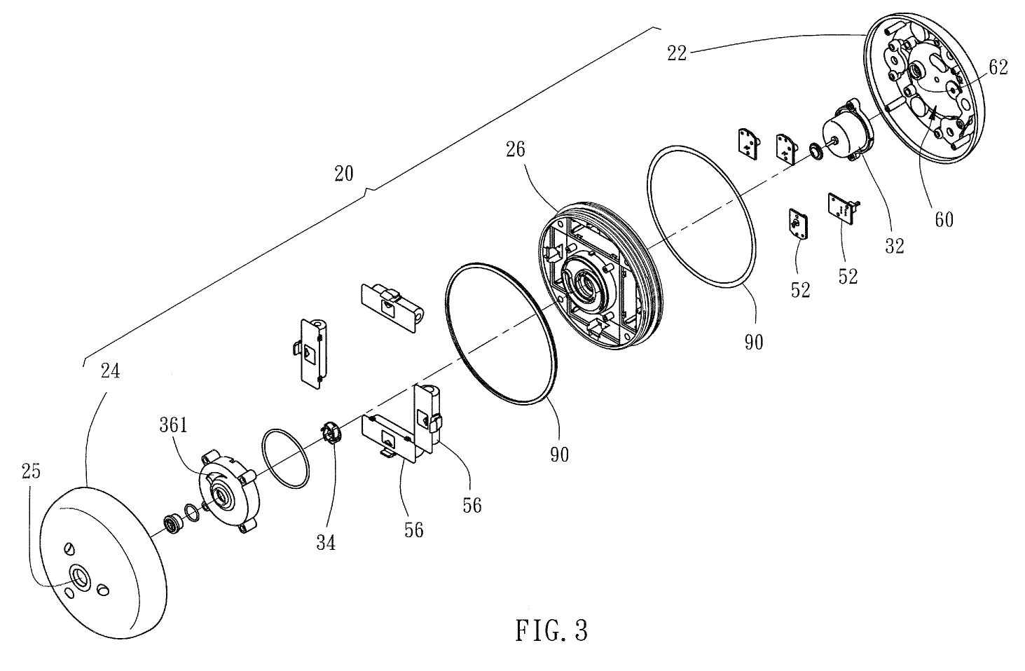

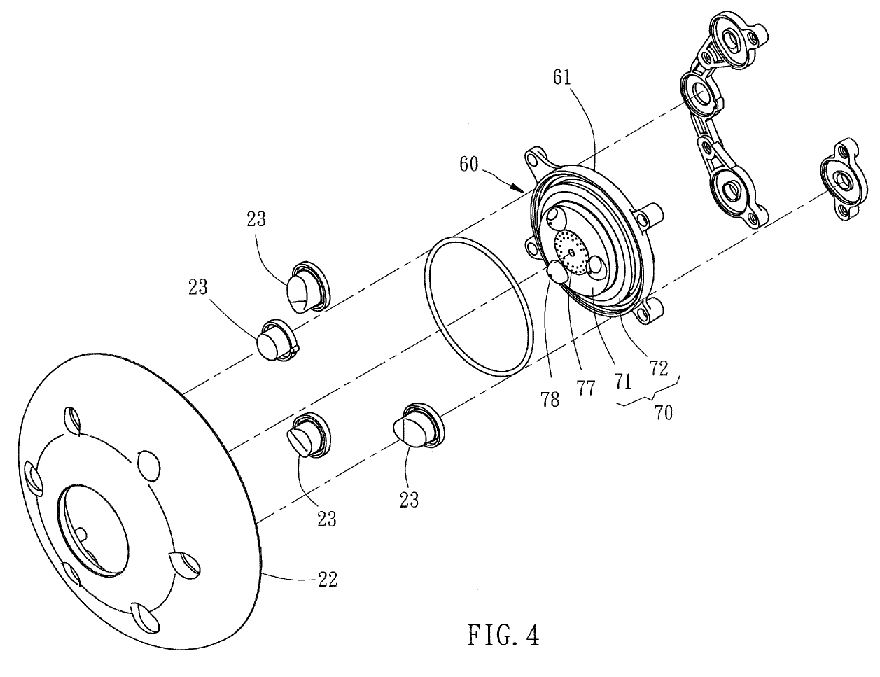

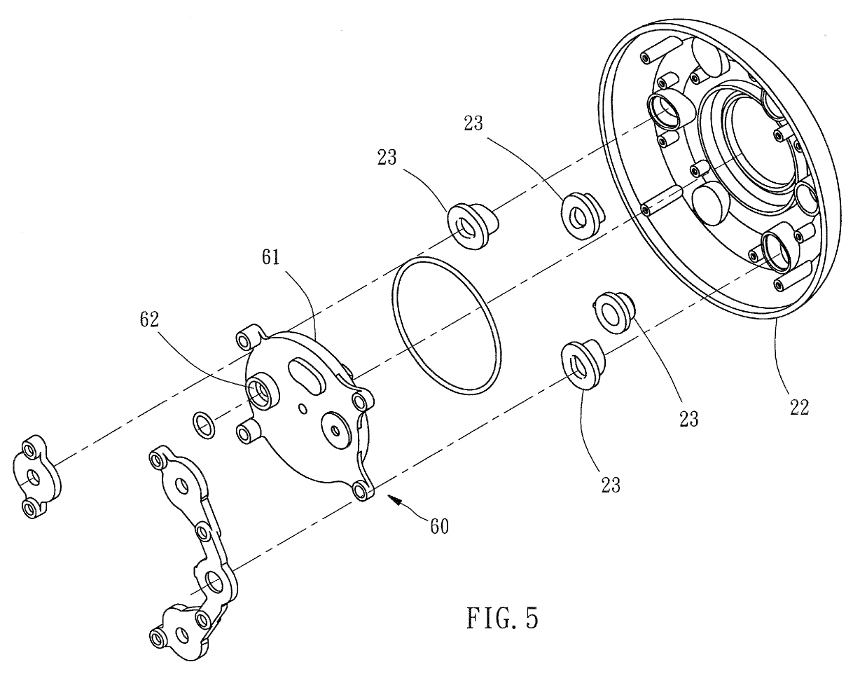

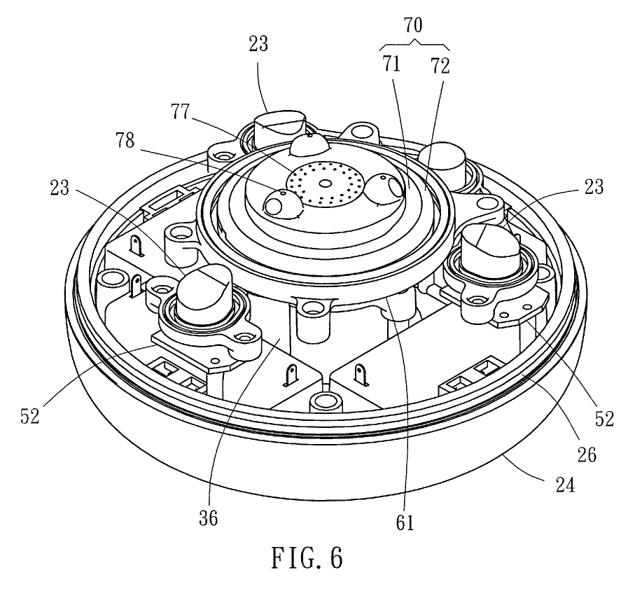

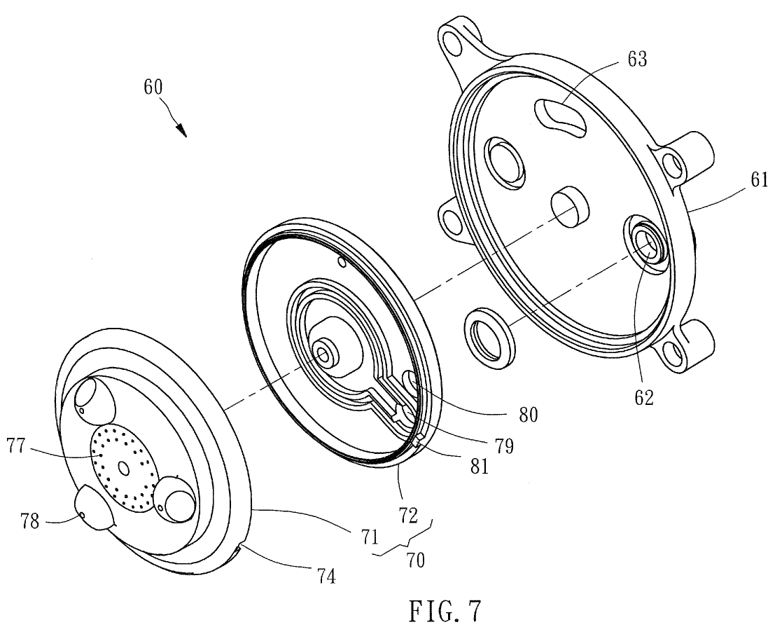

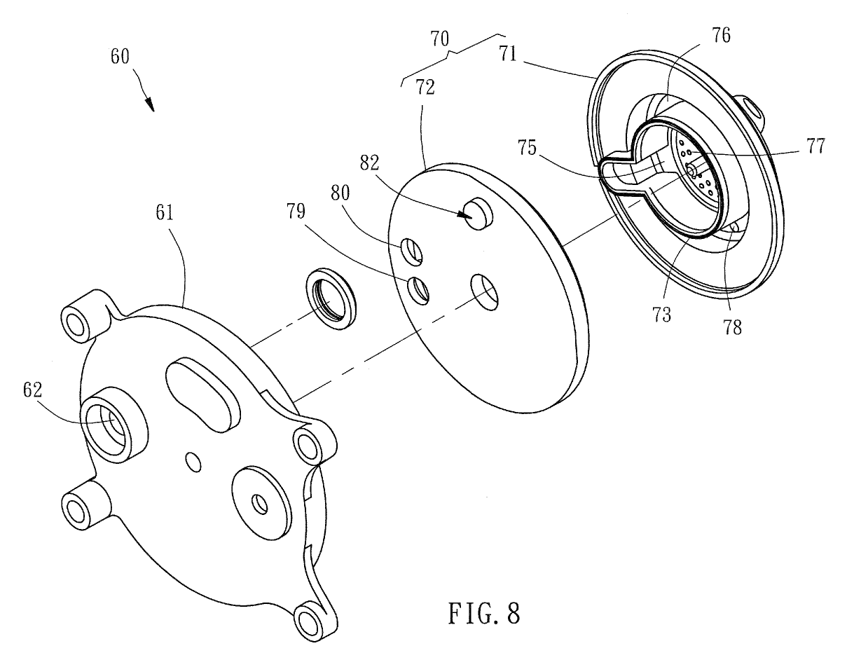

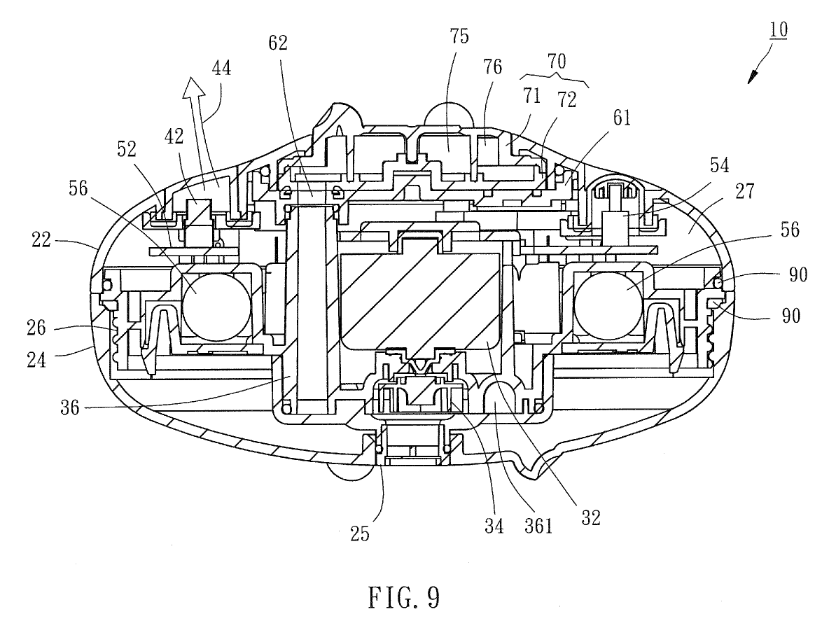

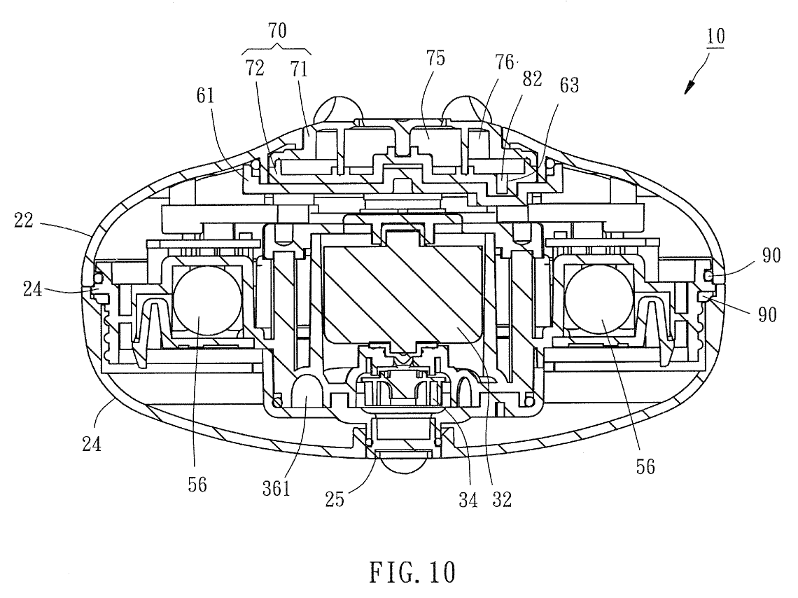

Referring to FIGS. 1-10, a fountain lamp 10 in accordance with the present invention is composed of a housing 20, a water pump unit 30, a light emitting device 40, a control unit 50, and a shifting unit 60.

The housing 20 includes a top cover 22, a bottom cover 24, and a body 26. The top cover 22 is closely covered on a top side of the body 26, having a plurality of lenses 23 embedded therein. The bottom cover 24 is closely covered on the bottom side of the body 26, having a water inlet 25. The top cover 22 and the bottom cover 24 define an accommodation chamber 27. The body 26 is positioned in the accommodation chamber 27. Further, two O-rings 90 are mounted between the body 26 and the top cover 22 and between the body 26 and the bottom cover 24 respectively to seal the accommodation chamber 27, prohibiting the water from entering the accommodation chamber 27.

The water pump unit 30 is mounted inside the accommodation chamber 27 for deliver of the water. The water pump unit 30 includes a motor 32, a vane 34, and a water delivery pipeline 36 for delivering the water. The motor 32 has a motor shaft 33. The vane 34 is mounted to the motor shaft 33. The water delivery pipeline 36 has one end connected to the water inlet 25 of the bottom cover 24, and the other end connected to the switch 60. Further, the water delivery pipeline 36 has a spiral runway 361 near the water inlet 25.

The light emitting device 40 mounted in the accommodation chamber 37 for corresponding to the lenses 23, including three light emitting diodes (LEDs) 42. When the light emitting device 40 is turned on, the LEDs 42 emit light rays 44 through the lenses 23 to the outside of the housing 20.

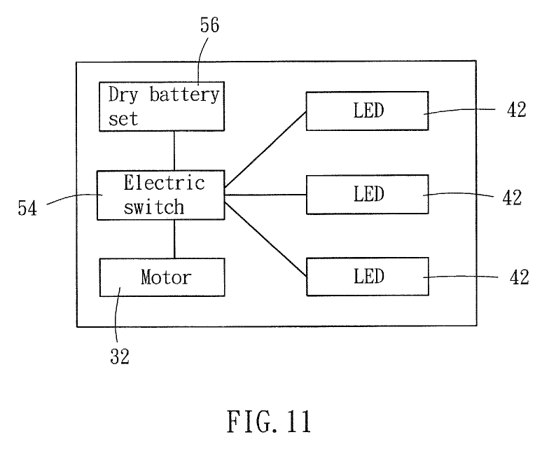

The control unit 50 includes a plurality of circuit boards 52, an electric switch 54, and a dry battery set 56. The circuit boards 52 carry and are electrically connected to the electric switch 54 and the light emitting device 40 respectively. The electric switch 54 is electrically connected to the dry battery set 56, the motor 32 of the water pump unit 30, and the light emitting device 40, for controlling the dry battery set 56 to drive the water pump unit 30 and the light emitting device 40, as shown in FIG. 11.

The aforesaid arrangement is substantially the same as conventional fountain lamps, therefore no further detailed description in this regard is necessary. The main features of the present invention are described hereinafter.

The shifting unit 60 includes a base 61 and a spray-pattern dial 70. The base 61 is mounted in the accommodation chamber 27, having a through hole 62 and an arched sliding groove 63. The through hole 62 is in communication with the water delivery pipeline 36. The arched sliding groove 63 is located on a top side of the base 61. The spray-pattern dial 70 includes of a top cover shell 71 and a bottom cover shell 72. The top cover shell 71 and the bottom cover shell 72 are closely covered on each other and rotatably mounted in the base 61. The top cover shell 71 has a rib 73 and a notch 74. The rib 73 partitions off the spray-pattern dial 70 to make a first water chamber 75 and a second water chamber 76. The first water chamber 75 is in communication with the outside through a plurality of first water outlets 77. The second water chamber 76 is in communication with the outside through a plurality of second water outlets 78. Each of the first water outlets 77 has a small diameter, such that fine mists of the water can be produced when the water passes through the water outlets 77. The diameter of the second water outlet 78 is relatively larger than that of the first water outlet 77, such that water columns can be produced when the water passes through the water outlets 78. The bottom cover shell 72 has a first water guide hole 79, a second water guide hole 80, a protruding block 81, and a limiter 82. The first water guide hole 79 is in communication with the first water chamber 75. The second water guide hole 80 is in communication with the second water chamber 76. One of the first and second water guide holes 79 and 80 corresponds to the through hole 62 so that the water is allowed to flow through one of the first and second water guide holes 79 and 80 into the first water chamber 75 or second water chamber 76. The protruding block 81 is engaged into the notch 74 of the top cover shell 71 to keep the respective water guide holes 79 and 80 in communication with the respective water chambers 75 and 76. The limiter 82 is provided at the bottom side of the bottom cover shell 72, and fixedly inserted into the arched sliding groove 63 to limit the rotational angle of the spray-pattern dial 70.

When using the fountain lamp 10, the user can press the electric switch 54, and then place the fountain lamp 10 on the water in, for example, a cistern or pool. At this time, the fountain lamp 10 floats on the water, and the water flows through the water inlet 25 along the spiral runway 361 into the water pump unit 30. By means of the rotation of the vane 34, the water is delivered through the water delivery pipeline 36 to the shifting unit 60. When the water enters the spiral runway 361, the flowing direction of the water is in conformity with the stirring direction of the vane 34, thereby lowering the resistance produced upon contact of the vane 34 with the water and preferably stabilizing the pressure of the water. When the water flows through the through hole 62 into the shifting unit 60, it will enter the first water chamber 75 if the through hole 62 is aligned with the first water guide hole 79. When the water enters the first water chamber 75, it flow out of the first water outlets 77 to form fine mists. At the same time, the LEDs 42 of the light emitting device 40 emit the rays 44 on the fine mists of the water to produce a dynamic visual effect. If the user wishes to change the spray pattern, the user can rotate the spray-pattern dial 70 to align the through hole 62 with the second water guide hole 80. At this time, the water enters the second water chamber 76, and then flows out of the second water outlets 78 to produce water columns, and therefore a different dynamic visual effect is produced.

As stated above, the invention improves the drawbacks of the prior art design, allowing the user to change the operation mode of the fountain lamp conveniently and rapidly. In addition, the fountain lamp can float on the water and be suitable for operation in the wet environment. Furthermore, the fountain lamp is safe in operation because the invention is based on the DC power supply.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A fountain lamp comprising
a housing having an accommodation chamber and an inlet located on a bottom side of said housing for entry of a fluid;
a pump unit mounted in said accommodation chamber, said pump unit having a delivery pipeline in communication with said inlet for delivery of the fluid;
a light emitting device mounted in said accommodation chamber for emitting light out of said housing; and
a control unit electrically connected to said pump unit and said light emitting device for controllably driving said pump unit and said light emitting device;
wherein the fountain lamp further comprises a shifting unit, said shifting unit having a base and spray-pattern dial, said base being mounted in said accommodation chamber and having a through hole in communication with said delivery pipeline, said spray-pattern dial being rotatably mounted in said base and having a plurality of chambers, a plurality of guide holes respectively connected to said chambers and one of which in communication with said through hole, and multiple sets of outlets respectively disposed in communication with said chambers for exit of the fluid selectively from said chambers and said housing for different fluid spray patterns.

2. The fountain lamp as claimed in claim 1, wherein said spray-pattern dial includes a top cover shell and a bottom cover shell.

3. The fountain lamp as claimed in claim 2, wherein said top cover shell has a rib partitioning off said spray-pattern dial to make a first chamber and a second chamber.

4. The fountain lamp as claimed in claim 2, wherein said top cover shell has a notch; said bottom cover shell has a protruding block engaged into said notch of said top cover shell to keep said guide holes in communication with said chambers respectively.

5. The fountain lamp as claimed in claim 2, wherein said base has an arched sliding groove; said bottom cover shell has a limiter fixedly inserted into said arched sliding groove to limit the rotation angle of said spray-pattern dial.

6. The fountain lamp as claimed in claim 1, wherein said delivery pipeline has a spiral runway close to said inlet.

7. The fountain lamp as claimed in claim 1, wherein said outlets have different diameters for different spray patterns of the fluid.
